(19) United States
(12) Patent Application Publication
(10) Pub. No.: US 2025/0031083 A1
(43) Pub. Date: Jan. 23, 2025

(54) METHOD, APPARATUS AND COMPUTER PROGRAM

(71) Applicant: Nokia Technologies Oy, Espoo (FI)

(72) Inventors: Umur KARABULUT, Munich (DE); Ahmad AWADA, Munich (DE); Ingo VIERING, Munich (DE); Subhyal BIN IQBAL, Munich (DE)

(21) Appl. No.: 18/717,631

(22) PCT Filed: Jan. 12, 2022
(86) PCT No.: PCT/EP2022/050506

§ 371 Date: Jun. 7, 2024

(51) Int. Cl. H04W 24/10; H04W 36/30; H04W 76/19

(52) U.S. Cl. CPC H04W 24/10; H04W 36/305; H04W 76/19

(57) ABSTRACT

There is provided an apparatus comprising means for: receiving, at a user equipment from a source cell, configuration information for reporting information associated with measurement sampling rates per antenna panel of the user equipment and per cell of the network, wherein the network comprises the source cell and one or more target cells; and sending, to a first cell of the network and based on the configuration information, a message comprising information associated with the sampling rates per antenna panel of the user equipment and per cell of the network.

### FIELD

The present application relates to a method, apparatus, and computer program and in particular but not exclusively to reporting information associated with sampling rates per antenna panel of a user equipment and per cell of a network.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is UTRAN (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP).

### SUMMARY

According to an aspect, there is provided an apparatus comprising means for: receiving, at a user equipment from a source cell, configuration information for reporting information associated with measurement sampling rates per antenna panel of the user equipment and per cell of the network, wherein the network comprises the source cell and one or more target cells; and sending, to a first cell of the network and based on the configuration information, a message comprising information associated with the sampling rates per antenna panel of the user equipment and per cell of the network.

The information associated with the sampling rates may comprise one or more of: a most recent sampling rate on an antenna panel that is used for mobility measurements of the source cell; a most recent sampling rate on an antenna panel that is used for mobility measurements of the one or more target cells; a most recent synchronization signal block periodicity of the source cell; a most recent synchronization signal block periodicity of the one or more target cells; a most recent channel state information reference signal periodicity of the source cell; and a most recent channel state information reference signal periodicity of the one or more target cells.

The means may be for recording the reported information prior to the reporting.

The configuration information may comprise a periodicity of the reporting, and wherein the sending may be performed based on the periodicity.

The first cell may be the source cell.

The means may be for: determining radio link failure at the user equipment; and re-establishing a connection with a first target cell of the one or more target cells, wherein the first cell is the first target cell.

The message may further comprise an indication of the radio link failure.

The means may be for: performing a handover operation from the source cell to a first target cell of the one or more target cells, and wherein the sending is performed responsive to performing the handover.

According to an aspect, there is provided an apparatus comprising means for: sending, to a user equipment from a source cell, configuration information for causing the user equipment to report information associated with measurement sampling rates per antenna panel of the user equipment and per cell of the network, wherein the network comprises the source cell and one or more target cells; and receiving, based on the configuration information, a message comprising information associated with the sampling rates per antenna panel of the user equipment and per cell of the network.

The information associated with the sampling rates may comprise one or more of: a most recent sampling rate on an antenna panel of the user equipment that is used for mobility measurements of the source cell; a most recent sampling rate on an antenna panel of the user equipment that is used for mobility measurements of the one or more target cells; a most recent synchronization signal block periodicity of the source cell; a most recent synchronization signal block periodicity of the one or more target cells; a most recent channel state information reference signal periodicity of the source cell; and a most recent channel state information reference signal periodicity of the one or more target cells.

The configuration information may comprise a periodicity of the reporting, and wherein the receiving may be based on the periodicity.

The message may further comprise an indication of radio link failure at the user equipment.

The message may be received from a target cell.

The message may be received from the user equipment.

The means may be for: analysing, based on the received information associated with the sampling rates, one or more mobility events associated with the user equipment.

The analysing may comprise determining at least one of: that the sampling rates per antenna panel of the user equipment and per cell of the network caused the one or more mobility events to occur; and the mobility event was performed too late or too early.

The means may be for sending, to a centralized network entity, at least one of: the information associated with the sampling rates per antenna panel of the user equipment and per cell of the network; information indicating that that the sampling rates per antenna panel of the user equipment and per cell of the network caused one or more mobility events to occur; and information indicating that the mobility event was performed too late or too early.

The means may be for: receiving, from the centralized network entity, one or more adjusted mobility parameters for the user equipment.

The one or more adjusted mobility parameters may comprise one or more cell individual offsets and/or one or more times to trigger.

According to an aspect, there is provided an apparatus comprising means for: receiving information associated with one or more sampling rates per antenna panel of a user equipment and per cell of a network; determining one or more adjusted mobility parameters for the user equipment based on the received information; and sending, to a source cell of the network, the determined one or more adjusted mobility parameters for the user equipment.

The information indicating the sampling rates may comprise one or more of: a most recent sampling rate on an antenna panel of the user equipment that is used for mobility measurements of the source cell; a most recent sampling rate on an antenna panel of the user equipment that is used for mobility measurements of the one or more target cells; a most recent synchronization signal block periodicity of the source cell; a most recent synchronization signal block periodicity of the one or more target cells; a most recent channel state information reference signal periodicity of the source cell; and a most recent channel state information reference signal periodicity of the one or more target cells.

The information may further comprise at least one of: information indicating that that the sampling rates per antenna panel of the user equipment and per cell of the network caused one or more mobility events to occur; and information indicating that the mobility event was performed too late or too early.

The one or more adjusted mobility parameters may comprise one or more cell individual offsets and/or one or more times to trigger.

The information may further comprise an indication of radio link failure at the user equipment.

The information may be received from the source cell.

According to an aspect, there is provided an apparatus comprising at least one processor and at least one memory including a computer program code, the at least one memory and computer program code configured to, with the at least one processor, cause the apparatus at least to: receive, at a user equipment from a source cell, configuration information for reporting information associated with measurement sampling rates per antenna panel of the user equipment and per cell of the network, wherein the network comprises the source cell and one or more target cells; and send, to a first cell of the network and based on the configuration information, a message comprising information associated with the sampling rates per antenna panel of the user equipment and per cell of the network.

The information associated with the sampling rates may comprise one or more of: a most recent sampling rate on an antenna panel that is used for mobility measurements of the source cell; a most recent sampling rate on an antenna panel that is used for mobility measurements of the one or more target cells; a most recent synchronization signal block periodicity of the source cell; a most recent synchronization signal block periodicity of the one or more target cells; a most recent channel state information reference signal periodicity of the source cell; and a most recent channel state information reference signal periodicity of the one or more target cells.

The at least one memory and at least one processor may be configured to cause the apparatus to record the reported information prior to the reporting.

The configuration information may comprise a periodicity of the reporting, and wherein the sending may be performed based on the periodicity.

The first cell may be the source cell.

The at least one memory and at least one processor may be configured to cause the apparatus to: determine radio link failure at the user equipment; and re-establish a connection with a first target cell of the one or more target cells, wherein the first cell is the first target cell.

The message may further comprise an indication of the radio link failure.

The at least one memory and at least one processor may be configured to cause the apparatus to: perform a handover operation from the source cell to a first target cell of the one or more target cells, and wherein the at least one memory and at least one processor may be configured to cause the apparatus to send the message responsive to performing the handover.

According to an aspect, there is provided an apparatus comprising at least one processor and at least one memory including a computer program code, the at least one memory and computer program code configured to, with the at least one processor, cause the apparatus at least to: send, to a user equipment from a source cell, configuration information for causing the user equipment to report information associated with measurement sampling rates per antenna panel of the user equipment and per cell of the network, wherein the network comprises the source cell and one or more target cells; and receive, based on the configuration information, a message comprising information associated with the sampling rates per antenna panel of the user equipment and per cell of the network.

The information associated with the sampling rates may comprise one or more of: a most recent sampling rate on an antenna panel of the user equipment that is used for mobility measurements of the source cell; a most recent sampling rate on an antenna panel of the user equipment that is used for mobility measurements of the one or more target cells; a most recent synchronization signal block periodicity of the source cell; a most recent synchronization signal block periodicity of the one or more target cells; a most recent channel state information reference signal periodicity of the source cell; and a most recent channel state information reference signal periodicity of the one or more target cells.

The configuration information may comprise a periodicity of the reporting, and wherein the receiving may be based on the periodicity.

The message may further comprise an indication of radio link failure at the user equipment.

The message may be received from a target cell.

The message may be received from the user equipment.

The at least one memory and at least one processor may be configured to cause the apparatus to: analyse, based on the received information associated with the sampling rates, one or more mobility events associated with the user equipment.

The at least one memory and at least one processor may be configured to cause the apparatus to determine at least one of: that the sampling rates per antenna panel of the user equipment and per cell of the network caused the one or more mobility events to occur; and the mobility event was performed too late or too early.

The at least one memory and at least one processor may be configured to cause the apparatus to send, to a centralized network entity, at least one of: the information associated with the sampling rates per antenna panel of the user equipment and per cell of the network; information indicating that that the sampling rates per antenna panel of the user equipment and per cell of the network caused one or more mobility events to occur; and information indicating that the mobility event was performed too late or too early.

The at least one memory and at least one processor may be configured to cause the apparatus to: receive, from the centralized network entity, one or more adjusted mobility parameters for the user equipment.

The one or more adjusted mobility parameters may comprise one or more cell individual offsets and/or one or more times to trigger.

According to an aspect, there is provided an apparatus comprising at least one processor and at least one memory including a computer program code, the at least one memory and computer program code configured to, with the at least one processor, cause the apparatus at least to: receive information associated with one or more sampling rates per antenna panel of a user equipment and per cell of a network; determine one or more adjusted mobility parameters for the user equipment based on the received information; and send, to a source cell of the network, the determined one or more adjusted mobility parameters for the user equipment.

The information indicating the sampling rates may comprise one or more of: a most recent sampling rate on an antenna panel of the user equipment that is used for mobility measurements of the source cell; a most recent sampling rate on an antenna panel of the user equipment that is used for mobility measurements of the one or more target cells; a most recent synchronization signal block periodicity of the source cell; a most recent synchronization signal block periodicity of the one or more target cells; a most recent channel state information reference signal periodicity of the source cell; and a most recent channel state information reference signal periodicity of the one or more target cells.

The information may further comprise at least one of: information indicating that that the sampling rates per antenna panel of the user equipment and per cell of the network caused one or more mobility events to occur; and information indicating that the mobility event was performed too late or too early.

The one or more adjusted mobility parameters may comprise one or more cell individual offsets and/or one or more times to trigger.

The information may further comprise an indication of radio link failure at the user equipment.

The information may be received from the source cell.

According to an aspect, there is provided a method comprising: receiving, at a user equipment from a source cell, configuration information for reporting information associated with measurement sampling rates per antenna panel of the user equipment and per cell of the network, wherein the network comprises the source cell and one or more target cells; and sending, to a first cell of the network and based on the configuration information, a message comprising information associated with the sampling rates per antenna panel of the user equipment and per cell of the network.

The information associated with the sampling rates may comprise one or more of: a most recent sampling rate on an antenna panel that is used for mobility measurements of the source cell; a most recent sampling rate on an antenna panel that is used for mobility measurements of the one or more target cells; a most recent synchronization signal block periodicity of the source cell; a most recent synchronization signal block periodicity of the one or more target cells; a most recent channel state information reference signal periodicity of the source cell; and a most recent channel state information reference signal periodicity of the one or more target cells.

The method may comprise recording the reported information prior to the reporting.

The configuration information may comprise a periodicity of the reporting, and wherein the sending may be performed based on the periodicity.

The first cell may be the source cell.

The method may comprise: determining radio link failure at the user equipment; and re-establishing a connection with a first target cell of the one or more target cells, wherein the first cell is the first target cell.

The message may further comprise an indication of the radio link failure.

The method may comprise: performing a handover operation from the source cell to a first target cell of the one or more target cells, and wherein the sending is performed responsive to performing the handover.

According to an aspect, there is provided a method comprising: sending, to a user equipment from a source cell, configuration information for causing the user equipment to report information associated with measurement sampling rates per antenna panel of the user equipment and per cell of the network, wherein the network comprises the source cell and one or more target cells; and receiving, based on the configuration information, a message comprising information associated with the sampling rates per antenna panel of the user equipment and per cell of the network.

The information associated with the sampling rates may comprise one or more of: a most recent sampling rate on an antenna panel of the user equipment that is used for mobility measurements of the source cell; a most recent sampling rate on an antenna panel of the user equipment that is used for mobility measurements of the one or more target cells; a most recent synchronization signal block periodicity of the source cell; a most recent synchronization signal block periodicity of the one or more target cells; a most recent channel state information reference signal periodicity of the source cell; and a most recent channel state information reference signal periodicity of the one or more target cells.

The configuration information may comprise a periodicity of the reporting, and wherein the receiving may be based on the periodicity.

The message may further comprise an indication of radio link failure at the user equipment.

The message may be received from a target cell.

The message may be received from the user equipment.

The method may comprise: analysing, based on the received information associated with the sampling rates, one or more mobility events associated with the user equipment.

The analysing may comprise determining at least one of: that the sampling rates per antenna panel of the user equipment and per cell of the network caused the one or more mobility events to occur; and the mobility event was performed too late or too early.

The method may comprise sending, to a centralized network entity, at least one of: the information associated with the sampling rates per antenna panel of the user equipment and per cell of the network; information indicating that that the sampling rates per antenna panel of the user equipment and per cell of the network caused one or more mobility events to occur; and information indicating that the mobility event was performed too late or too early.

The method may comprise: receiving, from the centralized network entity, one or more adjusted mobility parameters for the user equipment.

The one or more adjusted mobility parameters may comprise one or more cell individual offsets and/or one or more times to trigger.

According to an aspect, there is provided a method comprising: receiving information associated with one or more sampling rates per antenna panel of a user equipment and per cell of a network; determining one or more adjusted mobility parameters for the user equipment based on the received information; and sending, to a source cell of the network, the determined one or more adjusted mobility parameters for the user equipment.

The information indicating the sampling rates may comprise one or more of: a most recent sampling rate on an antenna panel of the user equipment that is used for mobility measurements of the source cell; a most recent sampling rate on an antenna panel of the user equipment that is used for mobility measurements of the one or more target cells; a most recent synchronization signal block periodicity of the source cell; a most recent synchronization signal block periodicity of the one or more target cells; a most recent channel state information reference signal periodicity of the source cell; and a most recent channel state information reference signal periodicity of the one or more target cells.

The information may further comprise at least one of: information indicating that that the sampling rates per antenna panel of the user equipment and per cell of the network caused one or more mobility events to occur; and information indicating that the mobility event was performed too late or too early.

The one or more adjusted mobility parameters may comprise one or more cell individual offsets and/or one or more times to trigger.

The information may further comprise an indication of radio link failure at the user equipment.

The information may be received from the source cell.

According to an aspect, there is provided a computer readable medium comprising program instructions for causing an apparatus to perform at least the following: receiving, at a user equipment from a source cell, configuration information for reporting information associated with measurement sampling rates per antenna panel of the user equipment and per cell of the network, wherein the network comprises the source cell and one or more target cells; and sending, to a first cell of the network and based on the configuration information, a message comprising information associated with the sampling rates per antenna panel of the user equipment and per cell of the network.

The information associated with the sampling rates may comprise one or more of: a most recent sampling rate on an antenna panel that is used for mobility measurements of the source cell; a most recent sampling rate on an antenna panel that is used for mobility measurements of the one or more target cells; a most recent synchronization signal block periodicity of the source cell; a most recent synchronization signal block periodicity of the one or more target cells; a most recent channel state information reference signal periodicity of the source cell; and a most recent channel state information reference signal periodicity of the one or more target cells.

The program instructions may be for causing the apparatus to perform recording the reported information prior to the reporting.

The configuration information may comprise a periodicity of the reporting, and wherein the sending may be performed based on the periodicity.

The first cell may be the source cell.

The program instructions may be for causing the apparatus to perform: determining radio link failure at the user equipment; and re-establishing a connection with a first target cell of the one or more target cells, wherein the first cell is the first target cell.

The message may further comprise an indication of the radio link failure.

The program instructions may be for causing the apparatus to perform: performing a handover operation from the source cell to a first target cell of the one or more target cells, and wherein the sending is performed responsive to performing the handover.

According to an aspect, there is provided a computer readable medium comprising program instructions for causing an apparatus to perform at least the following: sending, to a user equipment from a source cell, configuration information for causing the user equipment to report information associated with measurement sampling rates per antenna panel of the user equipment and per cell of the network, wherein the network comprises the source cell and one or more target cells; and receiving, based on the configuration information, a message comprising information associated with the sampling rates per antenna panel of the user equipment and per cell of the network.

The information associated with the sampling rates may comprise one or more of: a most recent sampling rate on an antenna panel of the user equipment that is used for mobility measurements of the source cell; a most recent sampling rate on an antenna panel of the user equipment that is used for mobility measurements of the one or more target cells; a most recent synchronization signal block periodicity of the source cell; a most recent synchronization signal block periodicity of the one or more target cells; a most recent channel state information reference signal periodicity of the source cell; and a most recent channel state information reference signal periodicity of the one or more target cells.

The configuration information may comprise a periodicity of the reporting, and wherein the receiving may be based on the periodicity.

The message may further comprise an indication of radio link failure at the user equipment.

The message may be received from a target cell.

The message may be received from the user equipment.

The program instructions may be for causing the apparatus to perform: analysing, based on the received information associated with the sampling rates, one or more mobility events associated with the user equipment.

The analysing may comprise determining at least one of: that the sampling rates per antenna panel of the user equipment and per cell of the network caused the one or more mobility events to occur; and the mobility event was performed too late or too early.

The program instructions may be for causing the apparatus to perform sending, to a centralized network entity, at least one of: the information associated with the sampling rates per antenna panel of the user equipment and per cell of the network; information indicating that that the sampling rates per antenna panel of the user equipment and per cell of the network caused one or more mobility events to occur; and information indicating that the mobility event was performed too late or too early.

The program instructions may be for causing the apparatus to perform: receiving, from the centralized network entity, one or more adjusted mobility parameters for the user equipment.

The one or more adjusted mobility parameters may comprise one or more cell individual offsets and/or one or more times to trigger.

According to an aspect, there is provided a computer readable medium comprising program instructions for causing an apparatus to perform at least the following: receiving information associated with one or more sampling rates per antenna panel of a user equipment and per cell of a network; determining one or more adjusted mobility parameters for the user equipment based on the received information; and sending, to a source cell of the network, the determined one or more adjusted mobility parameters for the user equipment.

The information indicating the sampling rates may comprise one or more of: a most recent sampling rate on an antenna panel of the user equipment that is used for mobility measurements of the source cell; a most recent sampling rate on an antenna panel of the user equipment that is used for mobility measurements of the one or more target cells; a most recent synchronization signal block periodicity of the source cell; a most recent synchronization signal block periodicity of the one or more target cells; a most recent channel state information reference signal periodicity of the source cell; and a most recent channel state information reference signal periodicity of the one or more target cells.

The information may further comprise at least one of: information indicating that that the sampling rates per antenna panel of the user equipment and per cell of the network caused one or more mobility events to occur; and information indicating that the mobility event was performed too late or too early.

The one or more adjusted mobility parameters may comprise one or more cell individual offsets and/or one or more times to trigger.

The information may further comprise an indication of radio link failure at the user equipment.

The information may be received from the source cell.

According to an aspect, there is provided a non-transitory computer readable medium comprising program instructions for causing an apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a representation of a network system according to some example embodiments;

FIG. 2 shows a representation of a control apparatus according to some example embodiments;

FIG. 3 shows a representation of an apparatus according to some example embodiments;

FIG. 4 shows an example of a multi-panel user equipment;

FIG. 5 shows an example radiation pattern of each antenna panel of the user equipment in the example of FIG. 4;

FIG. 6 shows an example handover scheme;

FIG. 7 illustrates an example mobility scenario;

FIG. 8 shows some example L3 measurements from the scenario of FIG. 7;

FIG. 9 shows an example multi-panel user equipment mobility performance for different sampling periods;

FIG. 10 shows a method according to some examples;

FIG. 11 shows a method according to some examples; and

FIG. 12 shows a method according to some examples.

### DETAILED DESCRIPTION

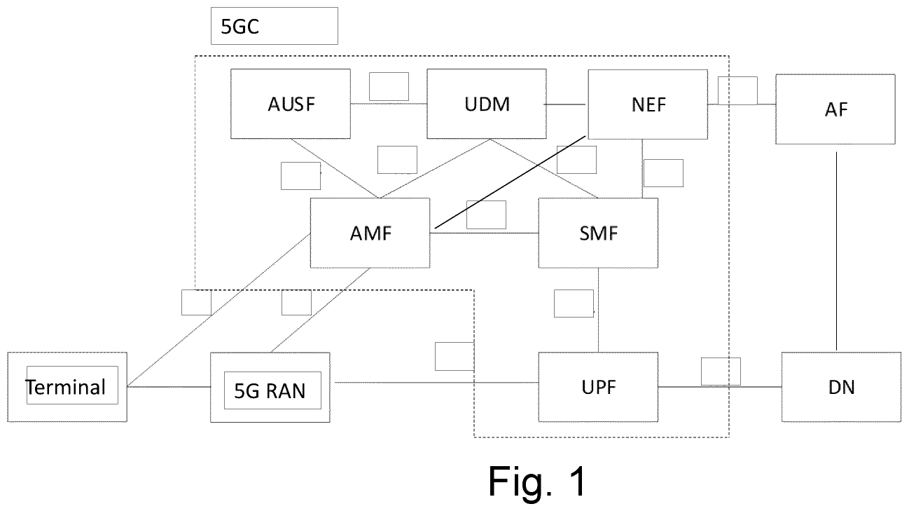

In the following certain embodiments are explained with reference to mobile communication devices capable of communication via a wireless cellular system and mobile communication systems serving such mobile communication devices. Before explaining in detail the exemplifying embodiments, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS). The 5GS may be comprised by a terminal or user equipment (UE), a 5G radio access network (5GRAN) or next generation radio access network (NG-RAN), a 5G core network (5GC), one or more application function (AF) and one or more data networks (DN).

The 5G-RAN may comprise one or more gNodeB (GNB) or one or more gNodeB (GNB) distributed unit functions connected to one or more gNodeB (GNB) centralized unit functions. The 5GC may comprise the following entities: Network Slice Selection Function (NSSF); Network Exposure Function; Network Repository Function (NRF); Policy Control Function (PCF); Unified Data Management (UDM); Application Function (AF); Authentication Server Function (AUSF); an Access and Mobility Management Function (AMF); and Session Management Function (SMF).

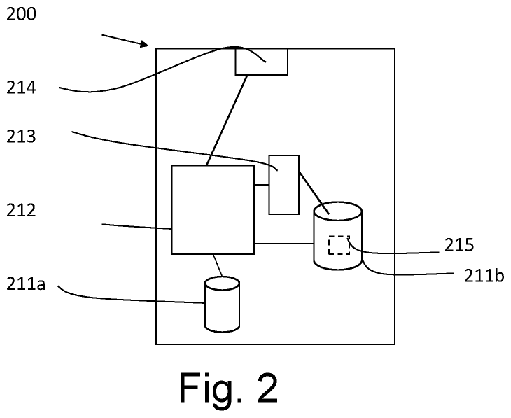

FIG. 2 illustrates an example of a control apparatus 200 for controlling a function of the 5GRAN or the 5GC as illustrated on FIG. 1. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5GRAN or the 5GC. In some embodiments, each function of the 5GRAN or the 5GC comprises a control apparatus 200. In alternative embodiments, two or more functions of the 5GRAN or the 5GC may share a control apparatus.

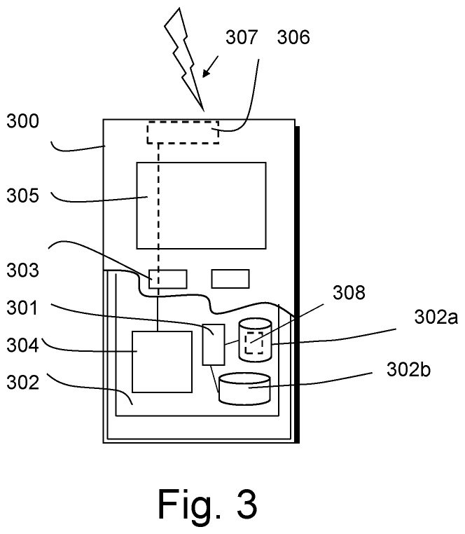

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, an Internet of things (loT) type communication device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

With the introduction of mmWave transmission in 3GPP 5G NR, the need to compensate for the additional path loss at higher transmission frequencies has lead to the proposal of antenna arrays at the base stations and User Equipment (UE). Patch arrays for mmWave at UE level may be very directive with up to 30 dB front-to-back ratio and lead to having multiple array panels covering multiple spatial directions.

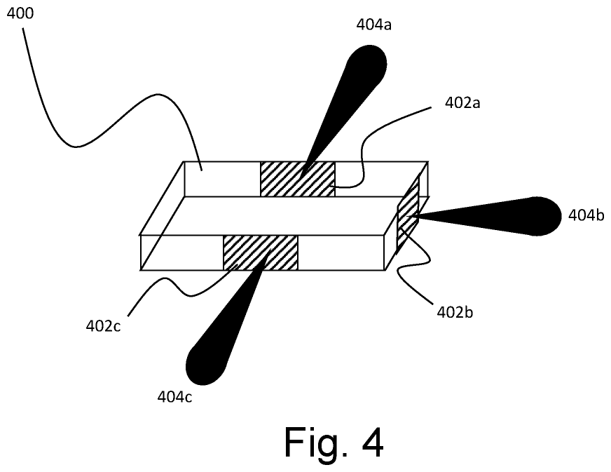

An illustrative example is shown in FIG. 4, where a multi-panel user equipment (MPUE) 400 has three panels 402a, 402b, 402c. Each panel has directional pattern 404a, 404b, 404c on different directions to cover the multiple spatial directions. It should be understood that in some examples the MPUE may have a different number of panels.

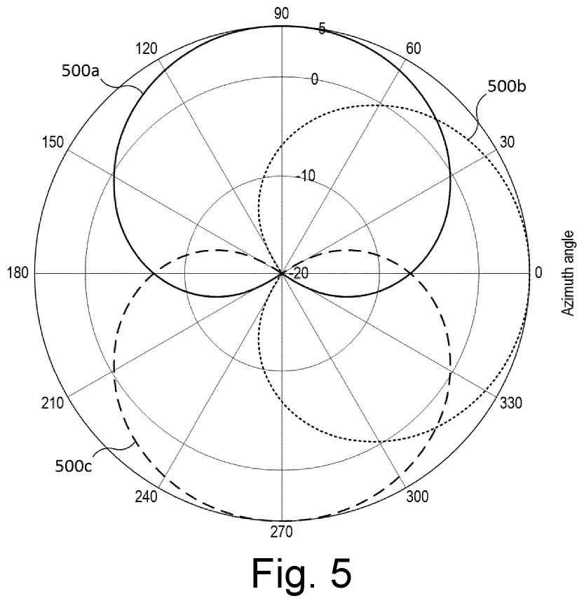

FIG. 5 shows an example radiation pattern of each antenna panels in the example of FIG. 4 in 2D, where each panel has 5 dBi antenna gain and 25 dB backwards attenuation. Radiation pattern 500a may correspond to antenna panel 402a, pattern 500b to antenna panel 402b, and pattern 500c to antenna panel 402c.

Depending on the UE hardware architecture, MPUEs may activate all panels simultaneously. As such, some MPUEs may be able to perform simultaneous measurements of serving cell and neighbour cell powers. However, each panel may be activated independently with different activation frequency. The activation periodicity of each panel determines the sampling rate of each panel, i.e., how often a panel does sampling of cell measurements over time. As will be explained in more detail below, the sampling rate may impact on mobility operations for the UE.

In mobile networks, a UE may connect to the network through a serving cell which provides a sufficiently good link quality, i.e., a link with signal-to-interference-noise-ratio above a certain threshold. If the UE moves away from the serving cell and gets closer to a neighbour cell (or target cell), the received signal power of the serving cell may degrade and the interference from the target cell may become dominant. Eventually, the UE performs handover to the target cell to sustain the connection to the network.

The received signal power of the serving cell may be compared against that of the target cell to determine whether it is necessary to handover the connection of the UE from the serving cell to the target cell. Those received signal power measurements may fluctuate due to channel impairments, e.g., fast-fading, measurement error and shadow fading. Using received signal power measurements without any filtering may lead to wrong handover decisions due to rapid fluctuations and uncertainty on the measured signals. To mitigate those impairments and uncertainty (to prevent erroneous decisions), the received signal power measurements may be filtered by moving average filter (L1 filter) and recursive filter (L3 filter) which may provide smooth measurement at the expense for the delay in the measurements (due to filtering).

UEs may measure the quality of the serving cell and neighbour cells, where those quality measurements are used to decide whether to handover a UE from one cell to another. Inaccurate cell quality measurements may lead to faulty handover decisions in the network and may cause UEs to experience service interruption, e.g., Radio Link Failure (RLF), Handover Failure (HOF) or Ping-Pong (PP). Therefore, it may be important for UE to achieve accurate cell quality measurements and good mobility performance.

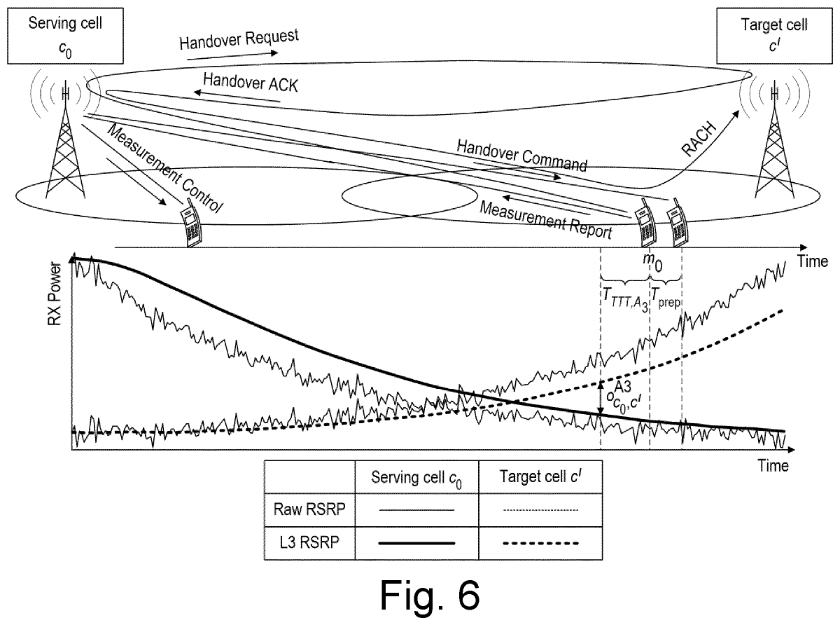

FIG. 6 shows an example handover scheme, where handover of a UE from serving cell co to neighbor cell c′ is illustrated along with the L3 measurements. During the handover procedure, L3 measurements (outputs of L3 filtering) from the serving and the neighbor cell are compared at the UE. In this example, if L3 measurements of a neighbor cell c′ is offset 0_{c}_{₀}_{,c′}^{A3}, dB better than the L3 measurement of the serving cell co for time-to-trigger period T_{TTT} of time, the UE sends a measurement report to the serving cell. The serving cell, upon receipt of the measurement report, sends a handover request to the target cell. If the target cell acknowledges the handover request, the serving cell sends a handover command to the UE. The UE then initiates the handover with a Random Access (RACH) procedure after receiving the handover command.

In the case of an MPUE, the number of measurements per cell may be scaled up with the number of panels on the UE. The UE may have to determine which panel measurements to be used for assessing each cell quality measurement.

As such, it may happen that the measurements of the serving cell and target cell are obtained from different panels, e.g., panel #1 is used for serving cell measurements and panel #2 is used for target cell measurements. This may occur when panel #1 and #2 gives the strongest measurements for serving cell and target cell respectively.

In some examples, the sampling rate per panel may differ among MPUEs due to, but not limited to, hardware limitations.

For example, in some UEs, multiple panels may not be able to be activated simultaneously for simultaneous measurements. In such cases, the UE may have to schedule the activation of the panels over time.

The scheduling may be based on a round robin scheduler, where one panel is activated at a time and one panel is activated after another panel is deactivated. An alternate approach may be to consider prioritization of the panels for certain mobility events, e.g., panels that are used in a most likely handover event (e.g., panel #1 and panel #2 from serving cell and target cell respectively), may be prioritized and sampling rate of those panels may be increased for accurate measurements whereas the panel #3 that is not needed in this most likely handover event is down-prioritized by reducing the sampling rate on that panel.

Furthermore, in some examples the UE may perform the cell quality measurements at the cost of power consumption. Even if a UE is capable of simultaneous measurement on all panels, the UE may operate under lower sampling rate per panel to reduce the power consumption on sampling. This may be the case when the UE implementation considers that accurate measurements are not needed, or when UE is running out of battery.

The sampling rate of each panel and panel activation periodicity may be determined by the UE and may be implementation specific.

In the case of an MPUE, the panel sampling rate may have a significant impact on mobility performance. Since the UE may measure the signal power of serving cell and neighbour cells periodically to assess the quality of each cell to be used in handover decisions, the panel sampling rate may determine the accuracy of the measurements.

For example, the following problems may occur:
A UE with a slow sampling rate acquires less number of samples (or statistics) in a given time period, which may lead to inaccurate measurements, and in turn lead to erroneous mobility decisions.
Power consumption of UE on measurement increases for increasing sampling rate which may lead to drainage of UE battery over time.

As such, there may be a trade-off between the measurement accuracy and power consumption when the sampling rate per panel per cell is considered. On the other hand, the sampling rate may be a UE decision and implementation specific where the network may not increase the sampling rate for the sake of improved mobility performance.

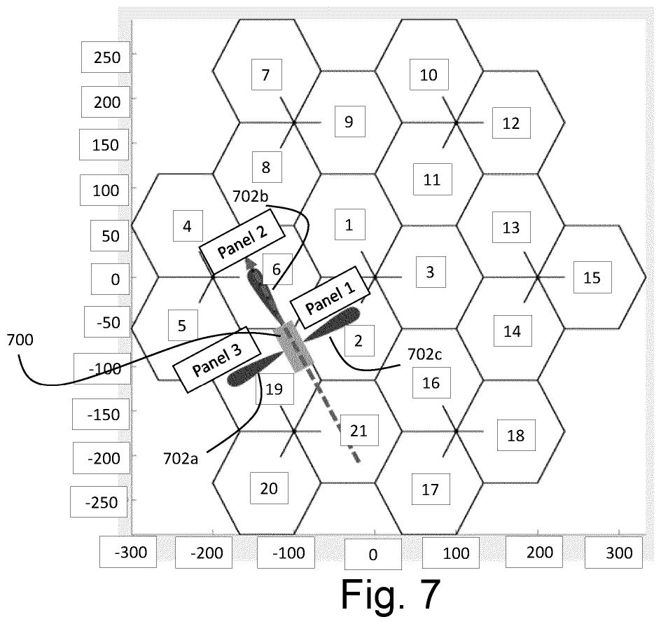

FIG. 7 illustrates an exemplary mobility scenario where UE 700 is moving along a direct path indicated by the arrow. The UE 700 comprises three panels, which each corresponding radiation patterns indicated by 702a, 702b, 702c. The grid shown in FIG. 7 represents different cells of a wireless network, where each cell is designated with a cell number.

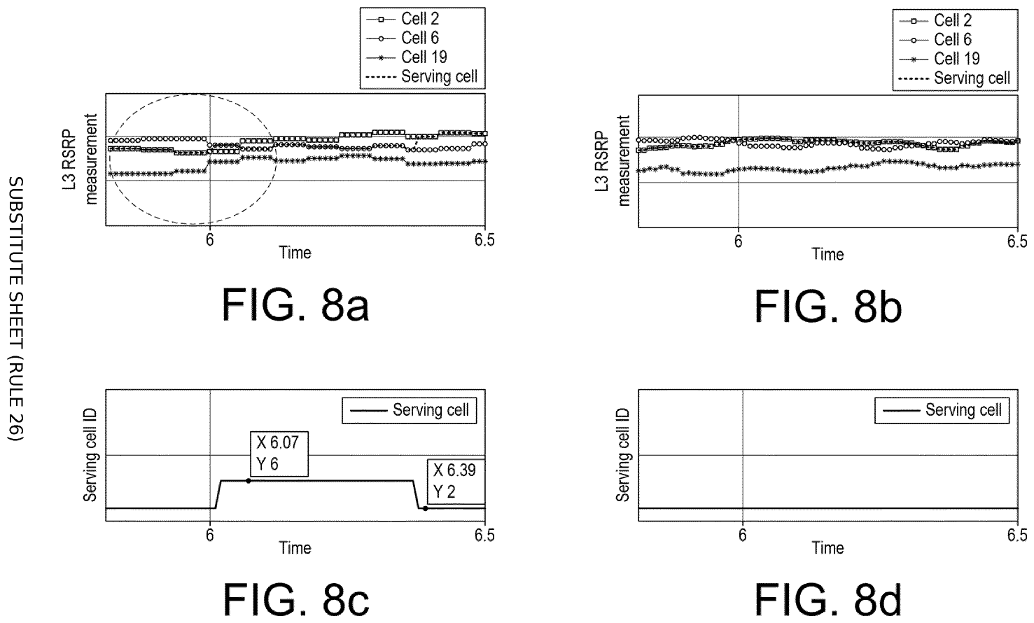

FIG. 8 shows some example L3 measurements taken by the UE in FIG. 7 for 60 ms and 20 ms sampling periods. In addition, in the example scenario of FIG. 8, every cell in the network transmits reference signal every 20 ms (Synchronization Signal Block (SSB) Signal with 20 ms period). In the graphs, simulated L3 RSRP measurements for cells 2, 6, 19, and a serving cell are shown in time that is varied on x-axis. At the beginning of the sampling duration, the UE is served by cell 2 and both cell 2 and cell 6 measurement values are close to each other.

In FIG. 8b, UE performs a new measurement every 20 ms, which follows the rapid changes in the received signal power. In FIG. 8a, UE performs a new measurement every 60 ms (although both cells transmit reference signals every 20 ms). The less frequent measurement shown in FIG. 8a leads UE to use non-updated measurements for L3 filtering and for evaluating handover conditions.

In FIG. 8a, it can be seen that for the first 6 (s) of measurement reporting (corresponding to the circled portion on FIG. 8a), the RSRP measurements for cell 6 are consistently higher than for cell 2.

In contrast, it can be seen from FIG. 8b that the RSRP measurements for cell 6 fluctuate over the same time period, and are actually lower than the RSRP measurements for cell 2 after 6 (s).

As the RSRP measurements for cell 6 remains higher than that for cell 2 at the 6 (s) mark in FIG. 8a, the UE may perform handover to cell 6 at time 6, as illustrated in FIG. 8c. However, as can be seen in FIG. 8a, shortly after 6 (s), the RSRP measurement value of cell 2 exceeds cell 6, indicating that the UE should perform handover back to cell 2. Thus, when using the sampling rate of FIG. 8a, the UE may “ping-pong” between cell 6 and 2, which may result in increased network traffic due to two consecutive handover operations being performed.

In contrast, FIG. 8b shows that the UE could have stayed in the serving cell 2 (as illustrated in FIG. 8d) to avoid performing an unnecessary two consecutive handover operations.

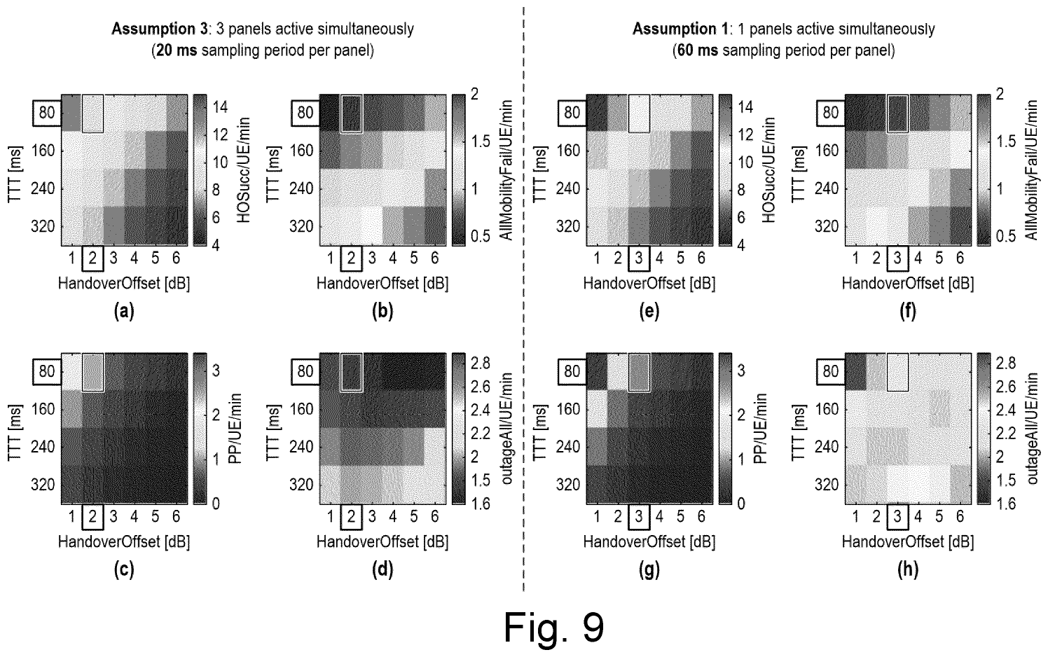

FIG. 9 shows the MPUE mobility performance for both 20 ms sampling period (fast sampling rate, assumption 3) and 60 ms sampling period (slow sampling rate, assumption 1). The mobility performance is shown by four mobility KPIs, as function of handover offsets (x-axis) and TTTs (y-axis). The mobility KPIs used in this example are:
Successful Handovers (HOSucc) in FIGS. 9a and 9e
All mobility failures (AllMobilityFail) in FIGS. 9b and 9f
Ping pongs (PP) in FIGS. 9c and 9g
Outages (outageAll, i.e., service interruption) in FIGS. 9d and 9h,

FIG. 9a-d show the mobility performance of MPUEs with 20 ms sampling period where FIG. 9e-h show the mobility performance of MPUEs with 60 ms sampling period.

FIG. 9 shows that the sampling rate per panel per cell may have a significant impact on the mobility performance, where MPUEs with slow sampling rate (four right most figures in FIG. 9) experiences more PPs, failures and outages in comparison to MPUEs with fast sampling rate (four left most figures in FIG. 9) when the mobility KPIs of the same handover offset and time-to-trigger (TTT) values are compared.

In some existing MPUE cases, the network may configure the same handover parameter for MPUEs in FR2 as the network cannot distinguish between MPUEs having different sampling rates. However, as shown previously with respect to FIG. 9, MPUEs with slow sampling rates may experience more mobility problems compared to MPUEs with fast sampling rates.

As shown in FIG. 9, MPUEs with 60 ms can have different handover parameter configuration than MPUEs with 20 ms, e.g., 3 dB offset instead of 2 dB to react better to ping-pongs. If the KPIs collected from MPUEs having different sampling rate are distinguished in order to avoid any mobility performance degradation for MPUEs with low sampling rate (if configured with same handover parameters for high sampling rate MPUEs), UE group-based mobility robustness optimization (MRO)—e.g. different MRO for MPUE1 and MPUE3—may be enabled.

In 3GPP Rel9, MRO assumes that the re-established cell after RLF is the candidate or target cell that UE should have performed handover to (assuming too late handover to re-established cell). This is further modified in 3GPP Rel10, where MRO includes a RLF report where more information, including measurements, are added to be used for root cause analysis.

When an RLF happens, the UE may store some information (e.g., available measurements) into an RLF Report and indicate the availability of such a report to the network during the re-establishment process. The network can retrieve this RLF Report and use its content to analyze the mobility problems. This may allow so called “offline” MRO based on the information in the RLF Report. This offline MRO does not necessarily have to be done right after re-establishment in the target/serving node, it can also be done in another entity collecting data over a longer time (e.g. trace collection entity).

In some current mobility procedures, root-cause analysis may be carried out without any information regarding the sampling rate per panel per cell that UE was using during mobility. Eventually, slow sampling rate related mobility problems may become misleading for network when optimizing the mobility parameters for improving the mobility performance.

It may therefore be beneficial for the network to be aware of the sampling rate per antenna panel of the UE, in order to improve MRO procedures.

In particular, certain aspects of the present disclosure may provide a method and apparatus to enable UE group-based MRO (different MRO for MPUE1 and MPUE3) where the KPIs collected from MPUEs having different sampling rate are distinguished in order to avoid any mobility performance degradation caused by MPUEs with low sampling rate. The method and apparatus may enable root-cause analysis to identify whether the mobility problem is caused by a slow sampling rate per panel per cell configuration of a UE or wrong mobility parameter configuration.

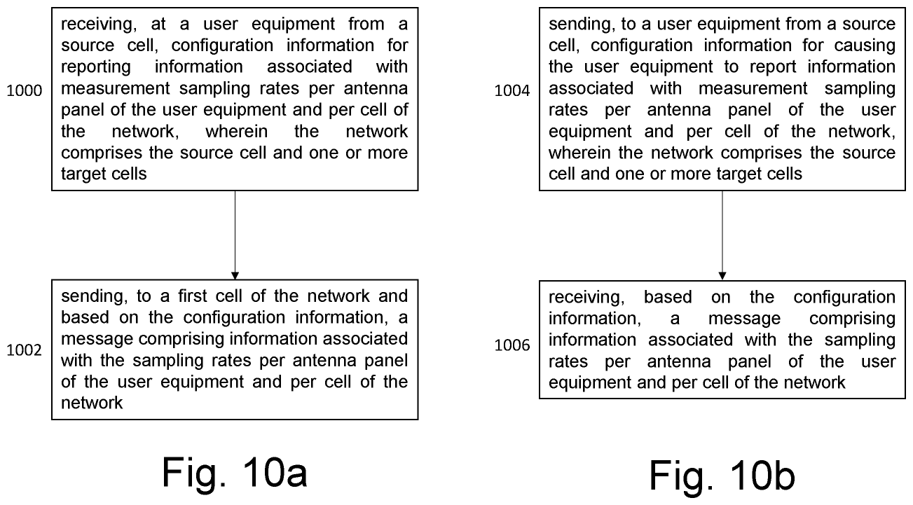

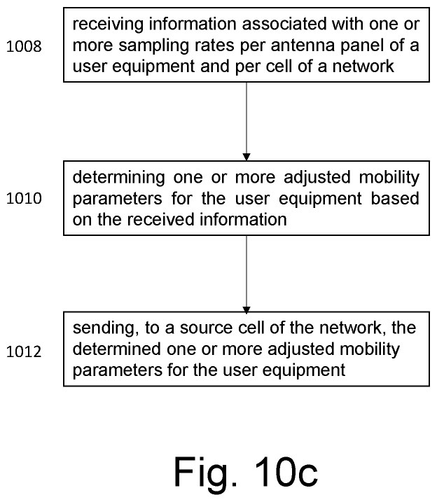

Reference is made to FIG. 10, which shows a method according to some examples.

In FIG. 10a, at step 1000, a method comprises receiving, at a user equipment from a source cell, configuration information for reporting information associated with measurement sampling rates per antenna panel of the user equipment and per cell of the network, wherein the network comprises the source cell and one or more target cells.

At step 1002, the method comprises sending, to a first cell of the network and based on the configuration information, a message comprising information associated with the sampling rates per antenna panel of the user equipment and per cell of the network.

In FIG. 10b, at step 1004, a method comprises sending, to a user equipment from a source cell, configuration information for causing the user equipment to report information associated with measurement sampling rates per antenna panel of the user equipment and per cell of the network, wherein the network comprises the source cell and one or more target cells.

At step 1006, the method comprises receiving, based on the configuration information, a message comprising information associated with the sampling rates per antenna panel of the user equipment and per cell of the network.

In FIG. 10c, at step 1008, a method comprises receiving information associated with one or more sampling rates per antenna panel of a user equipment and per cell of a network.

At step 1010, the method comprises determining one or more adjusted mobility parameters for the user equipment based on the received information.

At step 1012, the method comprises sending, to a source cell of the network, the determined one or more adjusted mobility parameters for the user equipment.

In some examples, the UE may report information associated with measurement sampling rates per panel per cell to the network. As will become apparent, this may allow the network to distinguish the slow sampling rate related mobility problems from wrong mobility parameter configuration related problems.

In some examples, the serving cell may configure the UE to report the most recent information associated with measurement sampling rates per panel per cell. The information may comprise a measurement sampling rate and/or the SSB periodicity of each cell (for example by adding the sampling rate information to RLF report) after the UE experiences RLF and re-establishes on a cell. In some examples, the serving cell may configure the UE to report the information associated with the measurement sampling rates periodically, for example to the source cell.

In some examples, the UE may report the most recent SSB periodicity of each cell and per panel sampling rate that UE observed during RLF.

Thus in some examples the network may acquire information on MPUE measurement behaviour over time, which may enable the network to perform more detailed root-cause analysis on mobility events, if needed.

In some examples, the sampling rate per panel per cell and/or information regarding the RLF may be either forwarded to the source cell (so called “distributed MRO”) or to a central network entity (so called “centralized MRO”), such as the Operation Administration and Maintenance (OAM) for root-cause analysis.

Hence, in both centralized and distributed MRO mechanisms, the network can apply the root-cause analysis by using the sampling rate per panel per cell of the UE and optionally SSB periodicity of each cell to understand if the mobility problems are caused by the slow sampling rate or not.

In some examples, the UE may configure a sampling rate per panel based on the SSB periodicity of network. For example, if the network transmits SSB every 160 ms (SSB periodicity), the UE may not measure any SSB within 160 ms (since there is not SSB within that period). Thus the UE may not activate the panel (or doesn't sample measurements) during this time although it may be capable of activating its panel more often than 160 ms period.

Therefore, the MPUE may report the SSB periodicity along with the sampling rate per panel per cell so that the network can distinguish whether the problem was caused by UE configuration (MPUE sampling rate) or network configuration (SSB periodicity).

The reported information may be provided in a RLF report. However, the method may also be applicable for successful handovers. For example, when UE completes a handover procedure successfully, it may include the sampling rate per panel per cell and SSB periodicity information in successful handover report so that the network can identify if handovers are caused by slow sampling rate configuration of a UE or not and optimize the mobility parameters accordingly. In addition, the method may also extend the reported SSB periodicity information to channel state information reference signals (CSI-RS), in case the mobility procedure is defined for CSI-RS measurements.

As explained above, proper configuration of mobility parameters may be important to achieve good mobility performance, i.e., less number of handover failures (HOFs), RLFs, PPs etc and reduced service interruption experienced by UEs in the network.

MRO is a method that is used to optimize mobility parameters such that the mobility robustness is improved. As explained before, this may be achieved by collecting the mobility related information, events on the network side. The mobility events may then be analyzed, i.e., applying root-cause analysis, to find out how to adjust the mobility parameters, e.g., time-to-trigger (TTT), Handover (HO) offsets, L3 filter coefficients etc.

Mobility problems can be caused by low sampling rate of UE, particularly in MPUE architectures. Mobility problems caused by low sampling rate should be distinguished by the MRO mechanisms so that the root-cause analysis and mobility parameter optimization is performed properly.

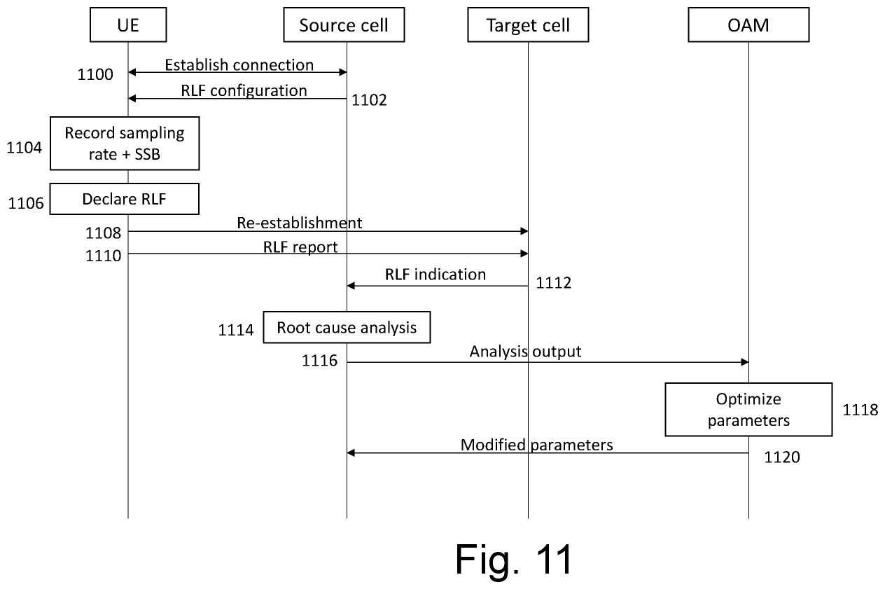

Reference is made to FIG. 11, which shows a method according to some examples. In the example method of FIG. 11, the UE reports the most recent sampling rate on panels and SSB periods of cells when the RLF or successful HO occurs.

At step 1100, the UE establishes a connection to the source cell and served by the source cell. Once the UE is connected to the source cell, the source cell configures the handover parameters for each neighbour cell that UE can do handover, e.g., target cell.

At step 1102, the source cell configures the UE to report information with the RLF report (if RLF occurs). The information reported may comprise one or more of:
a. Most recent sampling rate on the panel that is used for mobility measurements of source cell before RLF (R1),
b. Most recent sampling rate on the panel that is used for mobility measurements of the re-established cell (and possibly other target cells) before RLF (R2),
c. Most recent SSB periodicity of the source cell before RLF,
d. Most recent SSB periodicity of the re-established cell before RLF,

In some examples, the SSB periods may be known to the network. However, in some cases the source or re-established cell can re-configure their SSB periodicity during the time period (e.g. 48 hours) after which the RLF report may be sent by the UE. Furthermore, in some examples, the source cell and re-established cell may not store the SSB periodicity that was used when UE experienced RLF. Accordingly, in some examples the most recent SSB periodicity for the source cell and re-established cell may be included in the RLF report.

At step 1104, the UE records the most recent sampling rates of source cell (R1) and target cell including the cell to which UE re-establishes (R2) along with the most recent SSB periodicity of source cell and target cells.

At step 1106, the UE declares RLF. In some examples, the UE may declare RLF due to bad link quality between source cell and UE for T310 seconds.

At step 1108, the UE re-establishes an RRC connection on a new cell (target cell).

At step 1110, having re-established the connection, the UE sends the RLF report. The RLF report may include:
a. Most recent sampling rates on panels that are used for cell quality derivation of source and/or target cells, R1, R2 respectively.
b. Most recent SSB periodicity of source cell and/or target cell before RLF.

At step 1112, the target cell sends an RLF indication to the source cell. The RLF indication may include the additive content described in step 1110.

At step 1114, the source cell may analyze the RLF indication to identify the root-cause of the failure. In this step, the network can classify the type or RLF, such that:
a. RLF is caused by wrong handover parameter configuration; and/or
b. RLF is caused by slow sampling rate configuration of the UE (in virtue of R1, R2 and SSB periodicities).

In some examples, a lower limit of the UE sampling periodicity on a cell may be bounded by the SSB periodicity of the cell, i.e., UE cannot measure SSB of a cell if the SSB is not available. To help distinguish whether the slow sampling rate configuration of UE is caused by SSB periodicity of a cell or not (either source or target cell), both the RLF report and RLF indication may include both sampling rate and SSB periodicity information.

At step 1116, an output of the root-cause analysis is forwarded to the centralized network entity, e.g., OAM.

In some examples, the source cell forwards the UE sampling rates that are related to the RLF (e.g., R1, R2 and SSB periodicities) to the centralized network entity so that the centralized network entity can decide how to optimize the mobility parameters in the presence of reported information (centralized MRO).

In other examples, the source cell applies the root-cause analysis and forwards information to the centralized network entity. The information may indicate that the handover was too late (TL)/too early (TE) and/or to the wrong cell (WC), and/or indicate slow MPUE sampling.

At step 1118, the OAM uses the information from step 1116 and optimizes the mobility parameters, e.g., cell individual offsets (CIOs), TTTs accordingly. The OAM can either discard the slow sampling rate related mobility problems from optimization or apply a parameter optimization method that includes the sampling rate that UE used during RLF.

At step 1120, the OAM sends the optimized mobility parameters to the source cell.

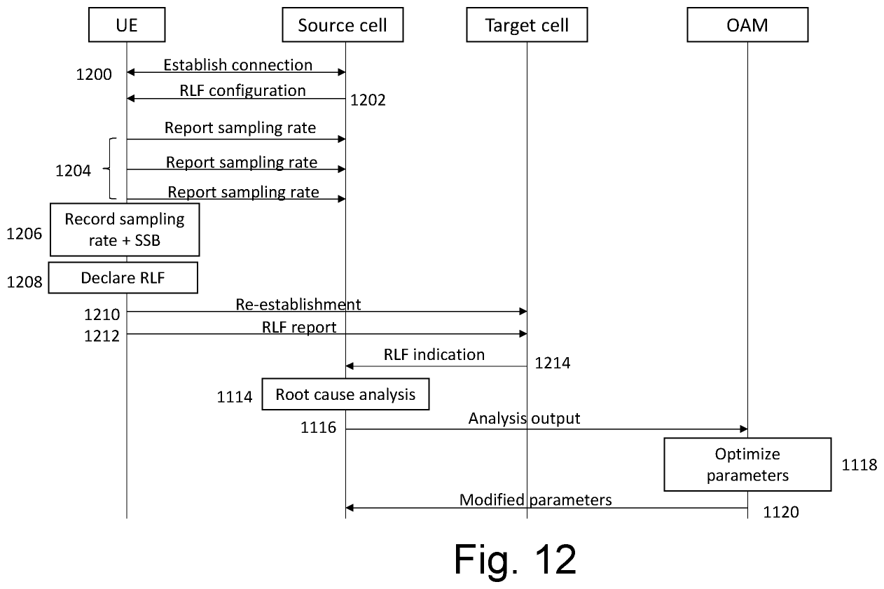

Reference is made to FIG. 12, which shows a method according to some examples. In the method of FIG. 12, the UE reports the sampling rate on panels and SSB periodicities of cells periodically.

At step 1200, the UE establishes a connection to the source cell and served by the source cell. Once the UE is connected to the source cell, the source cell configures the handover parameters for each neighbour cell that UE can do handover, e.g., target cell.

At 1202, the source cell configures UE to report information periodically. The information may comprise one or more of:
a. Most recent sampling rate on the panel that is used for mobility measurements of source cell before reporting,
b. Most recent sampling rate on the panel that is used for mobility measurements of the target cell before reporting,
c. Most recent SSB periodicity of the target cells before reporting.

At 1204, the UE reports the sampling rate on panels per cell that are used for mobility measurements and the SSB periodicity of target cell, periodically. As shown in the Figure, the UE may send the information a plurality of times, according to the time period and the periodicity configured by the source cell. While FIG. 12 shows three instances of the UE reporting the sampling rate to the source cell, it should be understood that in some examples, there may be more or fewer instances of the UE reporting the sampling rate.

At 1206, the source cell stores the periodic reported information. In some examples, the source cell stores all reported information. In other examples, the source cell stores the N most recent reported information. In some examples, N may be one.

The reported information may be stored to be used in case a root-cause analysis of a mobility event is needed. As explained previously, this can be useful if the network adapts the handover parameters based on the sampling rate that is reported by the UE.

At 1208, the UE declares RLF. In some examples, the UE may declare RLF due to bad link quality between source cell and UE for T310 seconds.

At step 1210, the UE re-establishes an RRC connection on a new cell (target cell).

At step 1212, having re-established the connection, the UE sends the RLF report. The RLF report may include:
a. Most recent sampling rates on panels that are used for cell quality derivation of source and target cells, R1, R2 respectively.
b. Most recent SSB periodicity of source cell and target cell before RLF.

In some examples, the SSB periodicities, R1, and R2 may change during service interruption that UE experiences during RLF. For example, the UE can experience up to 6000 ms service interruption before declaring RLF since T310 timer (RLF timer) can be configured in the range of 0-6000 ms. Including the most recent sampling rates and SSB periodicity in RLF report may provide the full information to the network that can be used for root-cause analysis with high resolution on the mobility problem.

At step 1214, the target cell sends the RLF indication to the source cell upon request. The RLF indication includes the information received at step 1212.

The rest of the steps in FIG. 12 follows steps 1114 to 1120 in FIG. 11, and so are not repeated here.

For the sake of simplicity, the methods described in relation to FIGS. 11 and 12 are described on an RLF scenario. However, it should be understood that the methods may also be applied for a successful HO scenario such that the PPs, and service interruption times are analyzed accordingly.

Furthermore, the methods may be applied for successful handover and CSI-RS measurements, i.e.,
reporting the mentioned information with successful handover report once the handover is completed successfully; and
Extending the reporting of SSB periodicity to CSI-RS periodicity when the CSI-RS measurements are used in mobility procedure.

Thus, according to the above-described methods, information is provided from UE to network such that the network can identify if a mobility event or mobility problem is caused by a UE with slow sampling rate configuration or not. This may enable the MRO mechanism to apply a proper root-cause analysis on mobility events and optimize the mobility parameters, i.e., discard the mobility problems caused by slow sampling rate or optimize mobility parameters per sampling rate (in case mobility parameters are configured per sampling rate). As such, some examples may result in improvements to the MRO mechanisms, and thereby lead to better network performance.

In some examples, there is provided an apparatus comprising means for receiving, at a user equipment from a source cell, configuration information for reporting information associated with measurement sampling rates per antenna panel of the user equipment and per cell of the network, wherein the network comprises the source cell and one or more target cells; and sending, to a first cell of the network and based on the configuration information, a message comprising information associated with the sampling rates per antenna panel of the user equipment and per cell of the network.

In some examples, the apparatus comprises at least one processor and at least one memory including a computer program code, the at least one memory and computer program code configured to, with the at least one processor, cause the apparatus at least to: receive, at a user equipment from a source cell, configuration information for reporting information associated with measurement sampling rates per antenna panel of the user equipment and per cell of the network, wherein the network comprises the source cell and one or more target cells; and send, to a first cell of the network and based on the configuration information, a message comprising information associated with the sampling rates per antenna panel of the user equipment and per cell of the network.

In some examples, there is provided an apparatus comprising means for: sending, to a user equipment from a source cell, configuration information for causing the user equipment to report information associated with measurement sampling rates per antenna panel of the user equipment and per cell of the network, wherein the network comprises the source cell and one or more target cells; and receiving, based on the configuration information, a message comprising information associated with the sampling rates per antenna panel of the user equipment and per cell of the network.

In some examples, the apparatus comprises at least one processor and at least one memory including a computer program code, the at least one memory and computer program code configured to, with the at least one processor, cause the apparatus at least to: send, to a user equipment from a source cell, configuration information for causing the user equipment to report information associated with measurement sampling rates per antenna panel of the user equipment and per cell of the network, wherein the network comprises the source cell and one or more target cells; and receive, based on the configuration information, a message comprising information associated with the sampling rates per antenna panel of the user equipment and per cell of the network.

In some examples, there is provided an apparatus comprising means for: receiving information associated with one or more sampling rates per antenna panel of a user equipment and per cell of a network; determining one or more adjusted mobility parameters for the user equipment based on the received information; and sending, to a source cell of the network, the determined one or more adjusted mobility parameters for the user equipment.

In some examples, the apparatus comprises at least one processor and at least one memory including a computer program code, the at least one memory and computer program code configured to, with the at least one processor, cause the apparatus at least to: receive information associated with one or more sampling rates per antenna panel of a user equipment and per cell of a network; determine one or more adjusted mobility parameters for the user equipment based on the received information; and send, to a source cell of the network, the determined one or more adjusted mobility parameters for the user equipment.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims.

Indeed, there is a further embodiment comprising a combination of one or more embodiments with any of the other embodiments previously discussed.

1. An apparatus comprising:
at least one processor; and
at least one memory including a computer program code, the at least one memory and computer program code configured to, with the at least one processor, cause the apparatus at least to perform the following:
receiving, at a user equipment from a source cell, configuration information for reporting information associated with measurement sampling rates per antenna panel of the user equipment and per cell of a network, wherein the network comprises the source cell and one or more target cells; and
sending, to a first cell of the network and based on the configuration information, a message comprising information associated with the sampling rates per antenna panel of the user equipment and per cell of the network.

2. The apparatus of claim 1, wherein the information associated with the sampling rates comprises one or more of:
a most recent sampling rate on an antenna panel that is used for mobility measurements of the source cell;
a most recent sampling rate on an antenna panel that is used for mobility measurements of the one or more target cells;
a most recent synchronization signal block periodicity of the source cell;
a most recent synchronization signal block periodicity of the one or more target cells;
a most recent channel state information reference signal periodicity of the source cell; and
a most recent channel state information reference signal periodicity of the one or more target cells.

3. The apparatus of claim 1, wherein the at least one memory and computer program code are configured to, with the at least one processor, cause the apparatus to record the reported information prior to the reporting.

4. The apparatus of claim 1, wherein the configuration information comprises a periodicity of the reporting, and wherein the sending is performed based on the periodicity.

5. The apparatus of claim 4, wherein the first cell is the source cell.

6. The apparatus of claim 1, wherein the at least one memory and computer program code are configured to, with the at least one processor, cause the apparatus to perform the following:
determining radio link failure at the user equipment; and
re-establishing a connection with a first target cell of the one or more target cells, wherein the first cell is the first target cell.

7. The apparatus of claim 6, wherein the message further comprises an indication of the radio link failure.

8. The apparatus of claim 1, wherein the at least one memory and computer program code are configured to, with the at least one processor, cause the apparatus to:
perform a handover operation from the source cell to a first target cell of the one or more target cells, and wherein the sending is performed responsive to performing the handover.

9. An apparatus comprising:
at least one processor; and
at least one memory including a computer program code, the at least one memory and computer program code configured to, with the at least one processor, cause the apparatus at least to perform the following:
sending, to a user equipment from a source cell, configuration information for causing the user equipment to report information associated with measurement sampling rates per antenna panel of the user equipment and per cell of a network, wherein the network comprises the source cell and one or more target cells; and
receiving, based on the configuration information, a message comprising information associated with the sampling rates per antenna panel of the user equipment and per cell of the network.

10. The apparatus of claim 9, wherein the information associated with the sampling rates comprises one or more of:
a most recent sampling rate on an antenna panel of the user equipment that is used for mobility measurements of the source cell;
a most recent sampling rate on an antenna panel of the user equipment that is used for mobility measurements of the one or more target cells;
a most recent synchronization signal block periodicity of the source cell;
a most recent synchronization signal block periodicity of the one or more target cells;
a most recent channel state information reference signal periodicity of the source cell; and
a most recent channel state information reference signal periodicity of the one or more target cells.

11. The apparatus of claim 9, wherein the configuration information comprises a periodicity of the reporting, and wherein the receiving is based on the periodicity.

12. The apparatus of claim 9, wherein the message further comprises an indication of radio link failure at the user equipment.

13. The apparatus of claim 9, wherein the message is received from a target cell.

14. The apparatus of claim 9, wherein the message is received from the user equipment.

15. The apparatus of claim 9, wherein the at least one memory and computer program code are configured to, with the at least one processor, cause the apparatus to:
analyse, based on the received information associated with the sampling rates, one or more mobility events associated with the user equipment.

16. The apparatus of claim 15, wherein the analysing comprises determining at least one of:
that the sampling rates per antenna panel of the user equipment and per cell of the network caused the one or more mobility events to occur; and
the mobility event was performed too late or too early.

17. The apparatus of claim 9, wherein the at least one memory and computer program code are configured to, with the at least one processor, cause the apparatus to perform the following:
sending, to a centralized network entity, at least one of:
the information associated with the sampling rates per antenna panel of the user equipment and per cell of the network;
information indicating that that the sampling rates per antenna panel of the user equipment and per cell of the network caused one or more mobility events to occur; and
information indicating that the mobility event was performed too late or too early.

18. The apparatus of claim 17, wherein the at least one memory and computer program code are configured to, with the at least one processor, cause the apparatus to perform the following:
receiving, from the centralized network entity, one or more adjusted mobility parameters for the user equipment.

19. The apparatus of claim 18, wherein the one or more adjusted mobility parameters comprise one or more cell individual offsets and/or one or more times to trigger.

20-28. (canceled)

29. A method comprising:
receiving, at a user equipment from a source cell, configuration information for reporting information associated with measurement sampling rates per antenna panel of the user equipment and per cell of a network, wherein the network comprises the source cell and one or more target cells; and
sending, from the user equipment to a first cell of the network and based on the configuration information, a message comprising information associated with the sampling rates per antenna panel of the user equipment and per cell of the network.

30-31. (canceled)
